(19) United States
(12) Patent Application Publication
(10) Pub. No.: US 2015/0058167 A1
(43) Pub. Date: Feb. 26, 2015

(54) METHOD AND SYSTEM FOR DOMAIN NAME SEARCHING

(71) Applicant: Go Daddy Operating Company, LLC, Scottsdale, AZ (US)

(72) Inventors: Michael J. McLaughlin, Menlo Park, CA (US); Stacy Steinkuller, Phoenix, AZ (US); Paul E. Nicks, Marion, IA (US); Richard Merdinger, Iowa City, IA (US)

(73) Assignee: Go Daddy Operating Company, LLC, Scottsdale, AZ (US)

(21) Appl. No.: 13/973,833

(22) Filed: Aug. 22, 2013

(51) Int. Cl. G06Q 30/06

(52) U.S. Cl. CPC G06Q 30/0623
USPC 705/26.61

(57) ABSTRACT

A system and method are presented. A domain name registration website is provided by at least one server communicatively coupled to a network. The domain name registration website including a user interface. A query being entered by a requester into the user interface of the domain registration website is monitored. When the query being entered by the requester matches a predefined pattern, the query is used to identify a plurality of candidate domain names, and the candidate domain names are displayed for selection by the requester on the domain name registration website.

### CROSS-REFERENCE TO RELATED APPLICATIONS

This application is related to U.S. patent application Ser. No. ______, filed on ______, and entitled “METHOD FOR COMMUNICATING AN OFFER FOR A DOMAIN NAME.”

This application is related to U.S. patent application Ser. No. ______, filed on ______, and entitled “SYSTEM FOR COMMUNICATING AN OFFER FOR A DOMAIN NAME.”

### FIELD OF THE INVENTION

The present invention relates generally to transactions involving domain names and, more particularly, to systems and methods for facilitating the making of an offer of purchase for a domain name.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as web pages. Websites comprise a collection of connected, or otherwise related, web pages. The combination of all the websites and their corresponding web pages on the Internet is generally known as the World Wide Web (WWW) or simply the Web.

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites, some of which may offer and sell goods and services to individuals and organizations. Websites may consist of a single webpage, but typically consist of multiple interconnected and related web pages. Websites, unless extremely large and complex or have unusual traffic demands, typically reside on a single server and are prepared and maintained by a single individual or entity. Menus and links may be used to move between different web pages within the website or to move to a different website as is known in the art. The interconnectivity of web pages enabled by the Internet can make it difficult for Internet users to tell where one website ends and another begins.

Websites may be created using HyperText Markup Language (HTML) to generate a standard set of tags that define how the web pages for the website are to be displayed. Users of the Internet may access content providers' websites using software known as an Internet browser, such as MICROSOFT INTERNET EXPLORER or MOZILLA FIREFOX. After the browser has located the desired webpage, the browser requests and receives information from the webpage, typically in the form of an HTML document, and then displays the webpage content for the user. The user then may view other web pages at the same website or move to an entirely different website using the browser.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. If the domain name is not available for registration, the Internet user may keep selecting alternative domain names until an available domain name is found.

In some cases, entities that own particularly valuable domain names will put those domain names up for auction. In that case, if the domain name for which the Internet user has been searching has been placed up for auction, the Internet user can participate in the auction process by making a bid for the domain name. Auctions, however, are a relatively rare mechanism by which the sale of a domain name occurs. In most cases, if the user searches for a domain name and discovers that the domain name has already been registered, the user will simply select an alternative domain name for registration. Unfortunately, as the number of registered domain names increases, the number of satisfactory, unregistered, domain names diminishes.

In reality, the pool of available domain names is greater than simply unregistered or at-auction domain names. There are also a large number of registered domain names that the owner would be willing to sell, even though the domain name is not currently at auction. Sometimes, owners own a domain name, but do not make use of the domain name—the domain name simply sits idle. The registration for such a domain name may be maintained for the sole reason that the original registration had a very long term or the owner has setup automatic payments to ensure that the domain name is continuously registered, but has failed to cancel those automatic payments. In any case, the owner may have no desire to use and/or own the domain name, but has simply failed to put the domain name up for auction. Accordingly, the user's desired domain name may, in fact, be available for sale even though the domain name has been registered by another and is not currently up for auction.

In some cases, individuals or companies offer brokerage services through which an offer to purchase a domain name can be communicated to the owner of a domain name. These services, though, tend to rely on human interactions, such as phone calls to communicate offers. As such, the brokerage process is generally only used for negotiating sales of extremely expensive domain names. Brokerage services are not useful for individuals that wish to buy a domain name through an automated transaction that can be performed quickly and without involving additional parties.

### BRIEF DESCRIPTION OF THE DRAWINGS

FIG. 1 is a flowchart illustrating a method by which a registrar can receive a domain name query request from a user and then display a listing of results in response to the request.

FIG. 2 is a flowchart illustrating a method by which a registrar can receive a requester's offer to purchase an already-registered domain name.

FIG. 3A is a flowchart illustrating a method by which an offer, received from a requester, can be transmitted to a domain name owner.

FIG. 3B is a flowchart illustrating a method by which a counter-offer, received from a domain name owner, can be transmitted to a requester.

FIG. 4 is a flowchart depicting an alternative method for displaying a list of candidate domain names in response to domain name query terms supplied by a requester.

FIG. 5 is a flowchart depicting a method for providing a user with a drop list of candidate domain names.

FIG. 6 depicts an example user interface by which a requester can initiate a search for a domain name in accordance with the method of FIG. 1.

FIG. 7 depicts an example user interface displaying a listing of results in response to the user's query for a requested domain name.

FIG. 8 depicts an example offer form in accordance with the present disclosure.

FIG. 9 depicts an example formal offer that can be communicated to a domain name owner.

FIG. 10 depicts a menu of candidate domain names being displayed in response to a user beginning to type a domain name into a search text box.

FIG. 11 depicts a number of candidate domain names arranged in a tile configuration.

FIG. 12 is a block diagram depicting an example environment in which embodiments of the present methods may be performed.

FIGS. 13A-13G are a series of screenshots showing an example use case for the present system in which a requester searches for a candidate domain name and then submits an offer to purchase that domain name.

### DETAILED DESCRIPTION

The present disclosure relates generally to transactions involving domain names and, more particularly, to systems and methods for facilitating the making of an offer of purchase for a domain name.

In one implementation, the present disclosure provides a method including receiving, by at least one server communicatively coupled to a network, a request from a requester, and using the request to identify a plurality of candidate domain names. The method includes, for each one of the plurality of candidate domain names, determining whether the candidate domain name is registered, and, when the candidate domain name is registered, displaying the candidate domain name in a result listing on a domain registration website hosted by the at least one server in response to the request, and displaying a first user interface enabling the requester to submit an offer to purchase the candidate domain name, and, when the candidate domain name is not registered, displaying the candidate domain name in the result listing on the domain registration website in response to the request, and displaying a second user interface enabling the requester to purchase the candidate domain name.

In another implementation, the present disclosure provides a method including receiving, by at least one server communicatively coupled to a network, a request from a requester, using the request to identify a domain name, and determining whether the domain name is registered. The method includes, when the domain name is registered, displaying the domain name in a result listing in response to the request, and displaying a first user interface enabling the requester to provide an offer to purchase the domain name.

In another implementation, the present disclosure provides a method including receiving, by at least one server communicatively coupled to a network, an offer of purchase for a domain name from a requester, the offer of purchase identifying a monetary value, determining, by the at least one server, an owner of the domain name, and transmitting the offer of purchase for the domain name to the owner of the domain name.

In another implementation, the present disclosure provides a system including a server hosting a domain name registration website via a network and being configured to communicate over the network with a client computer. The server is configured to receive, via the client computer, a request from a requester, and use the request to identify a plurality of candidate domain names. The server is configured to, for each one of the plurality of candidate domain names, determine whether the candidate domain name is registered, and, when the candidate domain name is registered, display the candidate domain name in a result listing on a domain registration website hosted by the at least one server in response to the request, and display a first user interface enabling the requester to submit an offer to purchase the candidate domain name, and, when the candidate domain name is not registered, display the candidate domain name in the result listing on the domain registration website in response to the request, and display a second user interface enabling the requester to purchase the candidate domain name.

In another implementation, the present disclosure provides a system including a server hosting a domain name registration website via a network and being configured to communicate over the network with a client computer. The server is configured to receive, via the client computer, a request from a requester, use the request to identify a domain name, and determine whether the domain name is registered. The server is configured to, when the domain name is registered, display the domain name in a result listing in response to the request, and display a first user interface enabling the requester to provide an offer to purchase the domain name.

In another implementation, the present disclosure provides a system including a server hosting a domain name registration website via a network and being configured to communicate over the network with a client computer. The server is configured to receive, via the client computer, an offer of purchase for a domain name from a requester, the offer of purchase identifying a monetary value, determine, by the at least one server, an owner of the domain name, and transmit the offer of purchase for the domain name to the owner of the domain name.

In another implementation, the present disclosure provides a method including providing, by at least one server communicatively coupled to a network, a domain name registration website. The domain name registration website includes a user interface. The method includes monitoring a query being entered by a requester into the user interface of the domain registration website, and when the query being entered by the requester matches a predefined pattern, using the query to identify a plurality of candidate domain names, and displaying the candidate domain names for selection by the requester on the domain name registration website.

In another implementation, the present disclosure provides a method including receiving, by at least one server communicatively coupled to a network, a request from a requester, using the request to identify a domain name, and determining whether the domain name is registered. The method includes, when the domain name is not registered, displaying the domain name, displaying a first user interface enabling the requester to purchase the domain name, and displaying a plurality of purchase options associated with the domain name. The plurality of purchase options being determined by a top level domain of the domain name.

In another implementation, the present disclosure provides a system including a server hosting a domain name registration website via a network and being configured to communicate over the network with a client computer. The server is configured to display a user interface on the domain name registration website, monitor a query being entered by a requester into the user interface of the domain registration website via the client computer, and determine whether the query being entered by the requester matches a predefined pattern. The server is configured to, when the query being entered by the requester matches the predefined pattern, use the query to identify a plurality of candidate domain names, and display, via the client computer, the candidate domain names for selection by the requester on the domain name registration website.

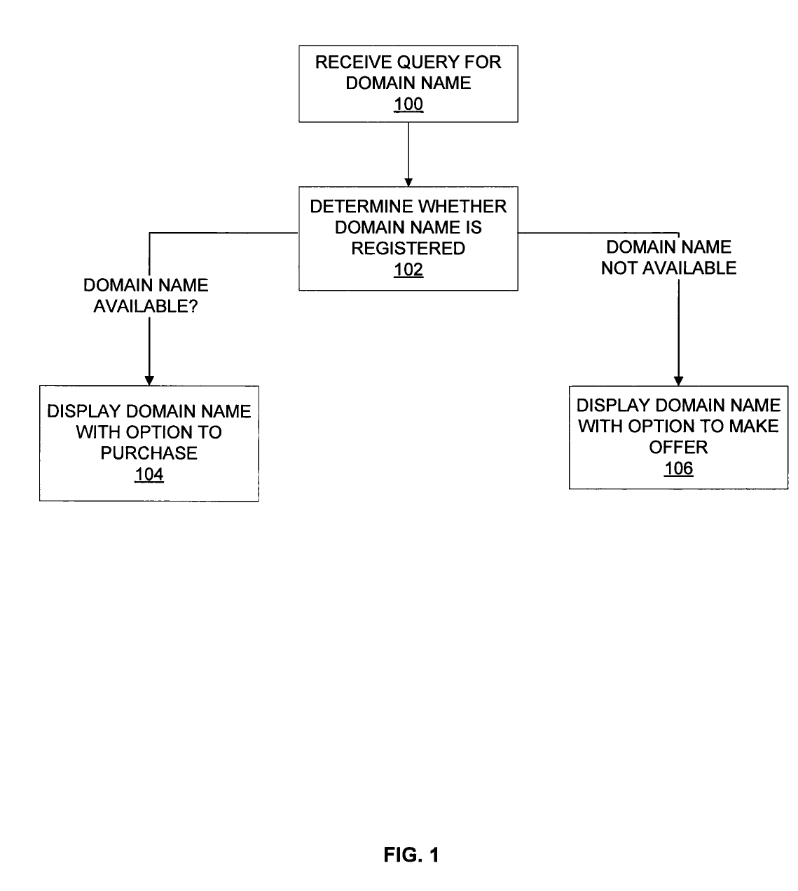

To acquire a domain name a user will often perform a search of the desired domain name at a registrar's domain name registration website. FIG. 1 is a flowchart illustrating a method by which a registrar and, specifically, a web site operated by the registrar, can receive a domain name query request from a user and then display a listing of results in response to the request. Depending upon the status of the requested domain name (e.g., registered or unregistered) the user may be presented with an option to purchase the domain name or to make an offer to purchase the domain name. As a non-limiting example, the method illustrated in FIG. 1 (and all methods described herein) may be performed by any central processing unit (CPU) in any computing system, such as a microprocessor running on a server, and executing instructions stored (perhaps as scripts and/or software) in computer-readable media accessible to the CPU, such as a hard disk drive on a server. Such a server may be communicatively coupled to a network (e.g., the Internet) and may receive a request for a domain name in accordance with step 100.

In the present disclosure, purchasing a domain name may refer to entering into a lease for a domain name in exchange for payment. The payment may consist of a monetary amount or any other exchange of value, such as the provision of services or exchange of domain name leases. The lease may be made for a domain name that had not been previously registered. For domain names that have been previously registered, the purchase may involve the creation of a new lease for the domain name, or the undertaking of a remaining portion of an existing lease. As such, the purchase (and corresponding change of ownership of a domain name) may involve a change of ownership of an existing lease, or the cancellation of the previous owner's existing lease for the domain name and the creation of a new lease for the new owner.

In step 100 a request including a domain name query is received using a suitable user interface. The request may come from any individual or entity having access to the network that may wish to research potential domain names for registration and may comprise any electronic request received by the server including, but not limited to, a Hyper Text Transfer Protocol (HTTP) request, email message, and/or Short Message Service (SMS) message (i.e., text message). The request may comprise any combination of data seeking information relating to a domain name. As non-limiting examples, the request may comprise an HTTP request transmitted to a domain name registrar's website.

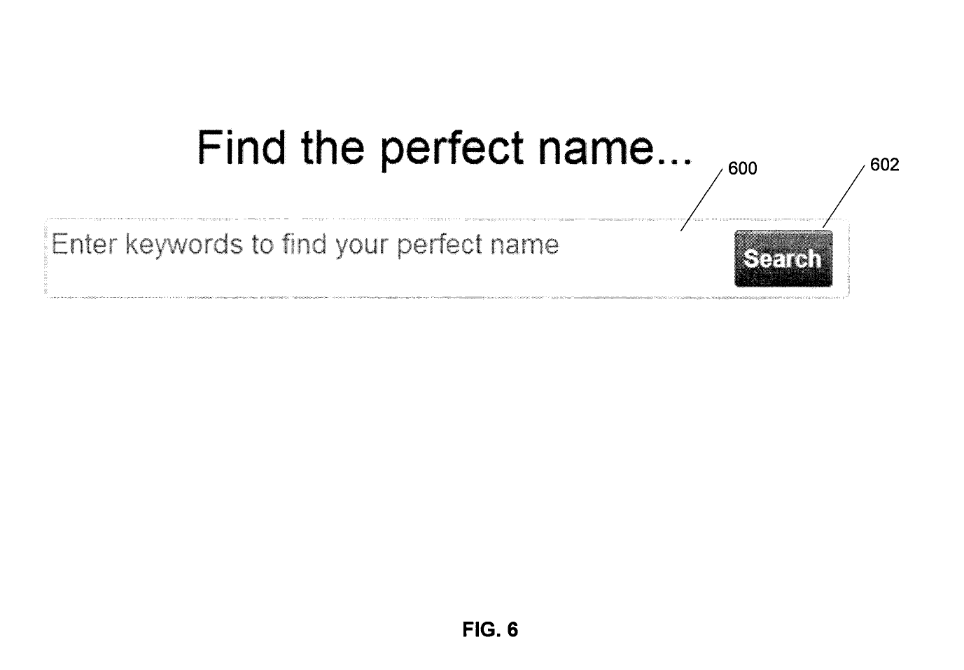

FIG. 6, for example, is a screenshot showing an example user interface by which a requester can initiate a search for a domain name in accordance with step 100 of FIG. 1. Referring to FIG. 6, the requester enters the name of the desired domain (e.g., mycompany.com”) into search box 600. Then, after the domain name has been entered into search box 600, the requester can activate button 602 to perform the query.

In some cases, rather than provide a domain name in search box 600, the requester instead enters a number of search terms that can be used to identify one or more potentially relevant domain name. If the input includes a number of search terms, a number of potential domain names may be identified, where the potential domain names have some relevancy to the entered search terms. When a number of search terms are entered, only the most relevant identified potential domain names may be included in a result set and displayed for the requester. In that case, if a domain name in the result set is not registered, the requester may be presented with an option to purchase the domain name. However, if a domain name in the result set is already registered, the requester may be presented with an option to make an offer to purchase the domain name.

In alternative embodiments, the requester may provide input other than a domain name or keywords in order to generate a listing of potential domain names for purchase or upon which to make an offer. The requester's input may generally comprise any input from which a suitable domain name may be derived. Example input includes explicit input comprising any data or information provided by the requester. Example explicit input may include text (e.g., newspaper content, personal statements, “about us” information for a business, a listing of favorite items such as products or sports teams, etc.), images (e.g., images of a place of business, images of an individual, images of products, etc.), audio (e.g. recordings of a band, audio of a company's jingle, audio of a commercial), and/or video (e.g., video of a comedy performance, video of a company's commercial, and the like) that may be uploaded by the requester. The explicit input can then be analyzed (e.g., by translating visual or audio information into text data) in order to identify potentially relevant domain names. The input may also include implicit data. Implicit data is information that may be derived from the requester or the request without the requester explicitly providing the information. Implicit data may include information such as the requester's current location (potentially derived from the IP address of the requester's computer), information associated with the requester in a customer information database (e.g., the market in which a business of the requester operates, the requester's age, sex, home address, nationality, native or secondary languages, etc.). In various implementations of the present system, any combinations of explicit or implicit data may be utilized or analyzed to identify one or more candidate domain names that may then be displayed to the requester in accordance with the present disclosure.

Returning to FIG. 1, after receiving the query (e.g., “mycompany.com”) in step 100, the system executes a query to determine whether the domain name identified in the query is already registered (step 102). This may involve, for example, ascertaining whether the requested domain name (e.g., “company.com”) has already been registered by checking the SRS database associated with the TLD of the domain name (.com in the instant example). Then, if the requested domain name is available for registration, in step 104 the domain is displayed back to the requester with an offer to purchase. The requester can then select the desired domain name and register the domain name. If, however, it is determined that the requested domain name is not available for registration because the domain name has already been registered by another, in step 106 the domain name is displayed back to the requester with an option to make an offer to purchase the domain. In some cases, this may involve also making the determination that the domain name is not actively for sale, for example because it is in an after-market domain name sales market. If the domain name is for sale in such a market, the requester may, rather than be provided an opportunity to make an offer on the domain name, instead may be directed to an aftermarket sales listing associated with the domain name.

In some cases, in addition to the search results for the requested domain name, a number of other domain names that may or may not be available for purchase can be listed in the results along with the searched-for domain name. Then other domain names included in the results may include domain names that are similar to the domain name in the query and may includes a number of auto-generated suggested domain names. If, in step 100 the requester submitted a query that included a number of search terms or other content, data, or implicit information, rather than a specific domain name, a search for domain names that are relevant to the query terms may turn up a number of results. In that case, one or more of the domain names included in the search results may be listed in conjunction with steps 104 or 106 of the method of FIG. 1.

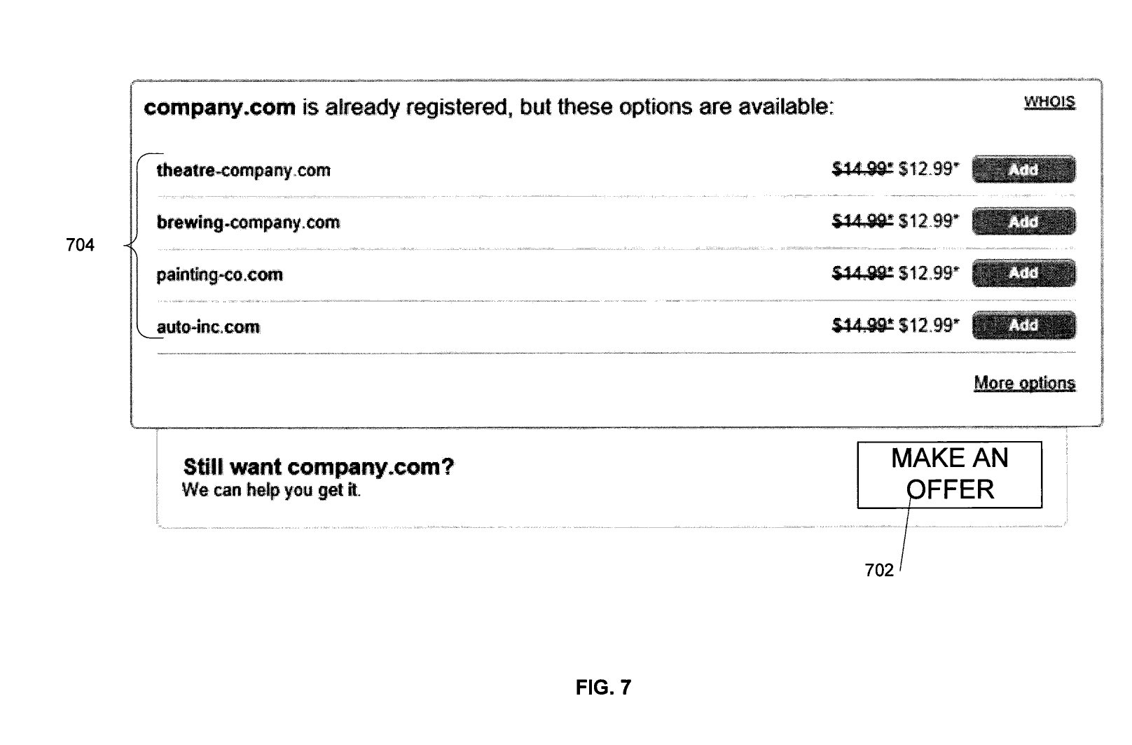

FIG. 7 is a screen shot showing an example user interface displaying a listing of results in response to the user's query for a requested domain name. As seen in FIG. 7, the requester has performed a search for the domain “company.com”. Having performed the search, the registrar's system has made the determination that the domain name is not available. As such, in the listing of search results, the domain name “company.com” is displayed, but next to the listing, the user is provided with a user interface (e.g., a button or link) 702 that may be used or activated to make an offer to purchase the domain name. In addition to the results for the domain name “company.com”, a number of additional domain names 704 are listed that the user may wish to register in place of or in addition to “company.com”. If the domain name were not registered, the listing would include a user interface, such as a button or link, enabling the requester to purchase the domain name.

Accordingly, if the requester wishes to make an offer to purchase the domain name “company.com”, the requester can click on the button 702 to initiate a process by which an offer can be made.

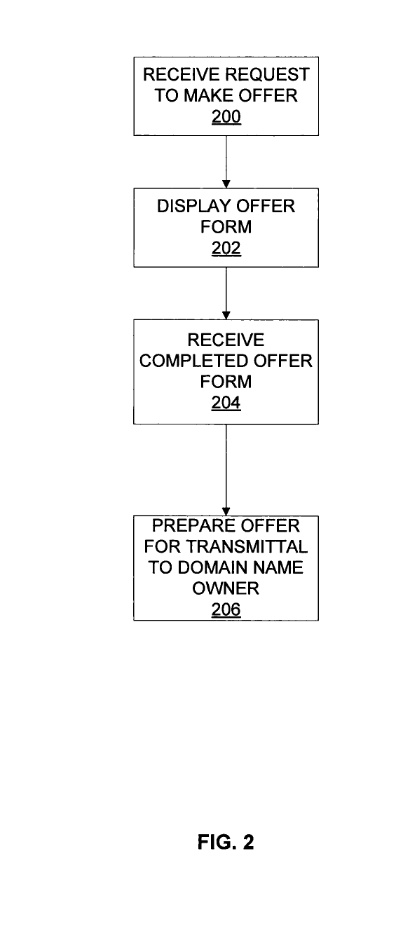

FIG. 2 is a flowchart illustrating a method by which a computer system operated by the registrar can receive a requester's offer to purchase an already-registered domain name. In step 200, a request is received from a requester to make an offer for a domain name that has already been registered. The request may be initiated, for example, by the user clicking on the ‘make an offer’ button 702 depicted in FIG. 7 for a domain name that has already been registered by another.

In some implementations, upon receiving a request to make an offer, the system can prompt the requester to log into a user account hosted by the registrar or, if the user does not have such an account, create one. By requiring the requester to log into or create an account with the registrar, the registrar can ensure that the registrar has contact information for the requester in order to facilitate any domain name transfer that may take place as a result of the offer.

In response to the request to make an offer, in step 202 an offer form is displayed for the requester to complete. The offer form may be presented as a single web page including a user-fillable form requesting all of the information necessary to complete an offer for a domain name. Alternatively, the form may be provided in a number of different web pages that can be displayed sequentially to the user as the user provides information. Some portions of the form may blank, requiring requester input. In some cases, however, portions of the form may be completed by the registrar. For example, if the requester is a customer of the registrar and has logged into a user account hosted by the registrar, the registrar can access one or more customer records to complete portions of the form automatically. Example information that may be automatically completed includes contact information for the requester, and payment information. For example, because the requester is a customer of the registrar, the registrar may maintain payment information for the requester that is used to pay for one or more services or products for the requester. The stored payment information may include credit card information, bank account or escrow service information, debit card information, or any other information allowing for the registrar to implement a financial transaction on behalf of the requester using the requester's funds or credit. Depending upon the implementation, for the automatically-completed portions of the offer form, the user may be given an option or opportunity to revise or otherwise modify the auto-completed information, for example to make corrections or update out-of-date information.

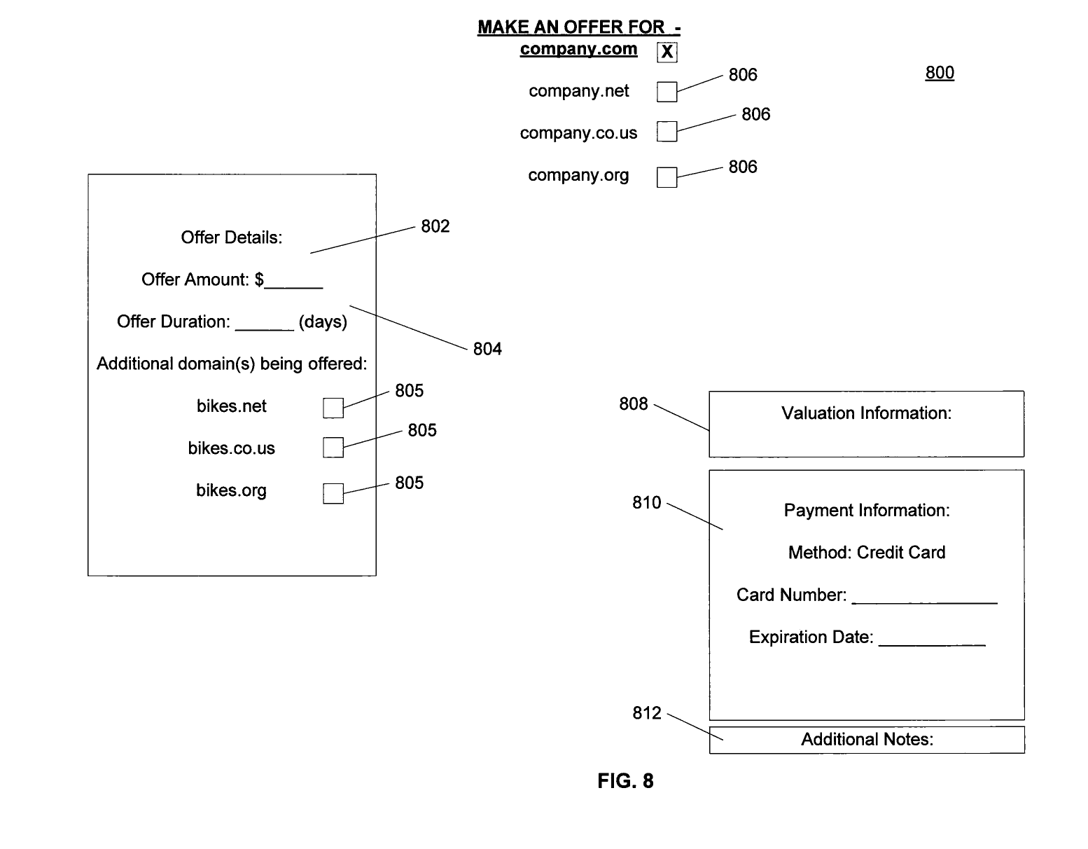

An example offer form is depicted in FIG. 8. Form 800 includes a space 802 in which the user can enter an amount of the offer. In one implementation, the offer amount will be a monetary amount. In other implementations, though, the offer may be in the form of an exchange of domain names. In that case, the requester may offer one or more domain names owned by the requester to trade in exchange for the target domain name of the offer (in this case, company.com), which may be in place of, or in addition to, a monetary amount. If the requester is a customer of the registrar, customer records of the requester can be analyzed to determine a number of domain names owned by the requester. Those domain names may then be listed on form 800 and the requester can be given an opportunity to select one or more of those domain names to add them to the terms of the offer amount. Accordingly, with reference to FIG. 8, the requester may check one or more of boxes 805 in order to add those requester-held domain names (i.e., bikes.net, bikes.co.us, and bikes.org) to the terms of the offer. If the offer is then accepted by the domain name owner, the listed domain names that were part of the requester's offer will be transferred to the domain name owner in a similar manner as the domain name that is the subject of the offer is transferred to the requester.

Additionally, the user can enter a duration of the offer 804, which sets a period of time in which the offer must either be accepted or rejected by the domain name owner or else the offer expires. Although FIG. 8 depicts an offer form in which the user can specify a duration for the offer, in some cases the offer duration is set by the registrar or another entity and cannot be modified by the requester. Alternatively, the owner of the domain name at issue may have specified a preference as to the duration of any offers that are made for the domain name.

If the owner of the domain name for which an offer is being provided also owns a number of other similar domain names, those other domain names may be included as part of the offer. For example, if the owner also owns a number of other domain names that are for the identical domain name, but with different TLDs, those domain names may be identified an included in the offer. A number of mechanisms can be used to identify other similar domain names that are also owned by the domain name. For example, if the domain name owner is a customer of registrar, the registrar can consult its customer records to identify the other domain names that are owned by the domain name owner. Alternatively, the registrar may consult WHOIS records to identify other domain names that are owned by the domain name owner.

In the present example, in addition to “company.com”, the owner also owns the domains “company.net”, “company.co.us”, and “company.org”. As such, those domain names are also listed in form 800. A number of check boxes 806 (or any other suitable user interfaces) are provided next to each of the other domains. If the requester completing the offer form 800 wishes to include any of those additional domain names as part of the offer, the requester can check one or more of boxes 806 to include those domain names as part of the offer. Note that because the depicted offer is for the domain name company.com, the box next to company.com is always checked.

Form 800 also includes region 808 that can display valuation information that may be useful to the requester in completing the offer. For example, if the domain name has been sold in the past, the value of those prior sales may be provided. In some cases, a number of other, similar, domain names may be identified that have sold within a particular time frame (e.g., within the last 6 months or year) and the prices of those sales could be listed. The similarity of domain names for comparable sales may be based upon a number of different metrics or attributes. For example, similar domain names may include those for companies that operate in the same market as that of the requester, as may be identified in the requester's customer information. The similarity may also be based upon amounts of traffic visiting the domain names. For example, comparable domain names may be those that exhibit similar amounts of traffic as that of the domain name that is the subject of the offer being made. The value of a domain name may also be affected by other factors, such as social sentiment, reputation (e.g., whether the domain name has hosted malicious content in the past), and the like. Many factors may be used in calculating a market value for the domain name, or a range of potential market values.

In region 808 other, more general, information could also be displayed in combination with the offer form. For example, the average cost of a domain name could be provided, or estimated domain name values for different markets (e.g., the average cost of a domain name in the restaurant market or hotel market). This information may all be helpful to the requester in selecting an appropriate amount for the offer.

Form 800 also includes region 810 in which the user can provide payment information. The payment information may include credit card information, debit card information, gift card information, back account information, or any other information enabling the transfer of money between the user and the owner of the domain name, should the user's offer be accepted.

Region 812 enables the user to input free-form text that can be communicated to the domain name owner upon submission of the offer.

After the offer form is completed, the user submits the offer form and, in step 204 of FIG. 2, the completed offer form is received by the registrar.

In step 206, having received the completed offer form, the registrar can then take the information that was submitted in the offer form and prepare a formal offer than can be communicated to the owner of the domain name. This may involve validating or authentication one or more of the pieces of information submitted by the requester. For example, the payment information provided by the requester can be verified as sufficient to process a transaction for the indicated offer amount should the offer be accepted. The verification of payment information may involve, for example, processing an authorization on credit card information provided by the requester for all or a portion of the amount of the offer. This may be executed, for example, at the time the offer is submitted, or any time thereafter.

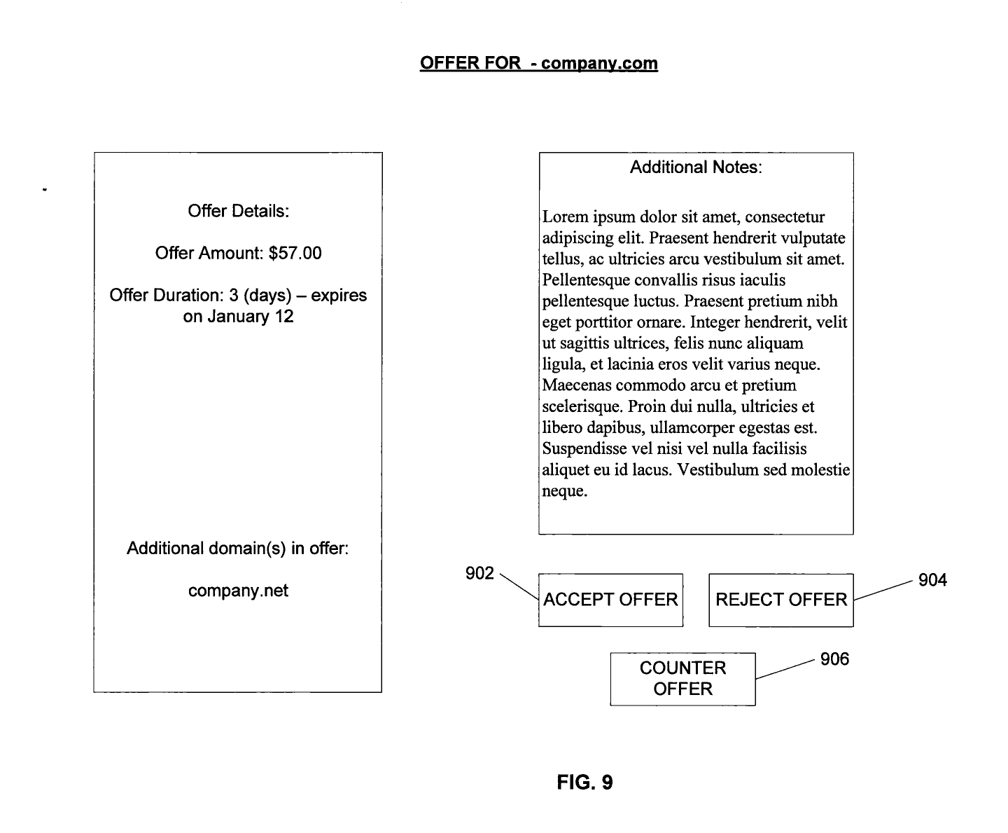

FIG. 9 is a screen shot showing an example formal offer that can be communicated to a domain name owner. The formal offer can be created based upon information supplied by a user using the interface depicted in FIG. 8.

In one implementation, the offer may be communicated to the domain name owner in the form of an email that can be sent to the domain name owner that includes all of the pertinent information in the offer. Alternatively, the domain name owner may be provided with a link or reference that can be utilized by the domain name owner to retrieve the details of the offer, for example, from a website. The offer may also be communicated via other forms of communication, such as through a fax message, voice message to the domain name owner's phone, text messages, or any other suitable mechanism for communicating either the offer or information enabling the domain name owner to review the offer details.

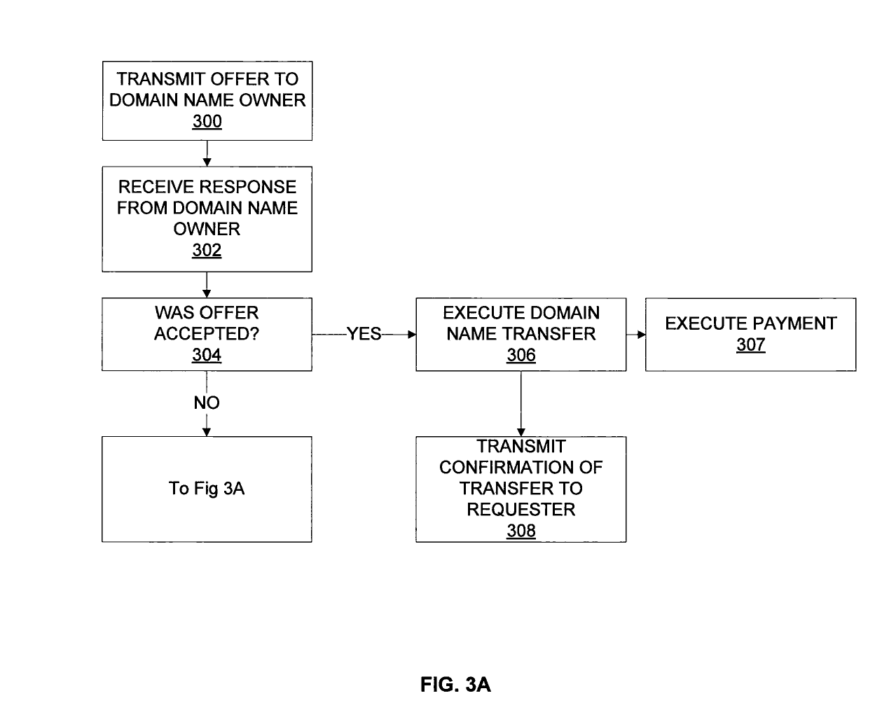

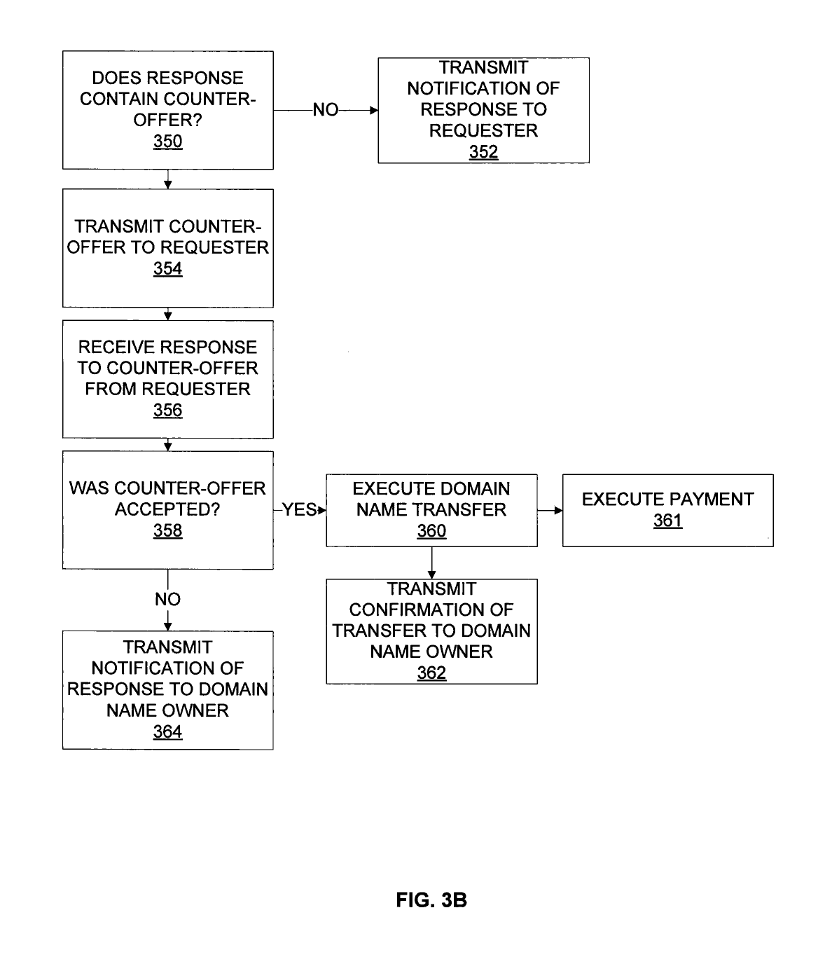

FIG. 3A is a flowchart illustrating a method by which an offer, received from a requester, can be transmitted to a domain name owner. Having received a completed offer form (see, for example, the method of FIG. 2) and prepared a corresponding offer notification, in step 300 the owner of the requested domain name is identified and the offer is transmitted to the domain name owner by the registrar.

In some cases, the requested domain is registered with the registrar performing the method of FIG. 3A. In that case, the registrar may be able to identify the domain name owner by reviewing the registrar's own customer records. If that is the case, the registrar can access the customer records to identify, for example, an email address for the domain name owner, or some other identifier (e.g., mailing address, etc.) by which the offer can be communicated to the domain owner. If the owner of the requested domain is not a customer of the registrar, the registrar can access the WHOIS records for the requested domain to access contact information either the domain owner or an individual responsible for the requested domain.

In some cases, the WHOIS records will not store direct contact information for the domain name owner because the domain name owner has a private registration. In that case, the registrar may contact the registrar for the domain name and request direct contact information for the domain name owner. To facilitate this transfer of information, the two registrars may have established a trusted relationship enabling both registrars to share this type of contact information for the purposes for facilitating the making of an offer to purchase a domain name.

In some cases, having identified the requested domain name owner, one or more preferences are identified for the requested domain name owner. The preferences may be stored, for example, in a customer records database accessible to the registrar. The preferences may define a number of constraints or requirements that must be met before an offer submitted on the owner's domain name will be forwarded to the owner. For example, the owner may specify a minimum amount that an offer must meet before the offer is transmitted to the owner. The minimum amount may be absolute (e.g., $50.00) or relative (e.g., 10% greater than the market rate for domain names having the same TLD). In some cases, a minimum offer may be established automatically and with none or only minimal input from the owner. In that case the minimum offer may be established based upon the domain name's market value, or the market value of domain names that are in a similar marketplace or group as the domain name. The owner's preferences may also describe a maximum number of offers that can be transmitted to the owner over a given time period.

In some cases, for one or more of the owner's domain name, the owner may set an offer amount that will be automatically accepted. These settings may be applicable across all domain names owned by the owner, or may be established on a per-domain name basis, where the preferences for each domain name owned by the owner are, optionally, different.

Having identified contact information for the owner of the domain that is the subject of the offer (and assuming that the offer meets any requirements specified by the domain name owner), the offer can be transmitted to the owner and in step 302 a response to the offer is received from the domain name owner. In one implementation, where the offer is transmitted to the owner in an email message, the email message may include a button or link that the owner can activate to accept the offer and initiate transfer of ownership of the domain name (see, for example, button 902 on the offer of FIG. 9). In other implementations, the offer may direct the domain owner to visit a website before the offer can either be accepted or rejected, for example by displaying a hyperlink that the domain name owner can click on to open a website depicting the details of the offer. In implementations, however, where the owner has established a monetary amount above which an offer will be automatically accepted, if the offer amount exceeds that predetermined amount, the offer will automatically be accepted and buttons 902, 904, and 906 will not be displayed. In some cases, however, if the offer does not exceed the minimum amount specified by the owner, a counter-offer will be automatically generated listing the owner's minimum amount as the requested purchase price. The counter-offer, listing the owner's minimum amount, will be transmitted to the requester pursuant to the methods described herein. The requester will then be given an opportunity to review the details of the counter-offer and, potentially, accept the counter-offer. At that time, if the requester accepts the counter-offer, the transaction will take place (the domain name ownership will be transferred to the requester and payment will be made to the domain name owner) without further input from either the requester or the domain name owner.

Also, as depicted in FIG. 9, the owner can select button 904 to reject the offer, in which case a notification of the rejection will be transmitted back to the requester. Similarly, the owner can select button 906 to initiate the process of submitting a counter-offer. Upon clicking on the button 906, the owner will be provided an opportunity to submit details of a counter-offer (e.g., the counter-offer amount), the details of which will then be transmitted back to the requester.

Before being able to view the details of the offer, the domain name owner may be required to provide authentication tokens (e.g., username and password) to log into the domain name owner's account with the registrar. In general, the offer may be communicated to the domain name owner using any suitable communication method. Examples include, but are not limited to, a reference or hyperlink to a website, where the website includes the contents and details of the offer, an email message, an SMS message (i.e., text message) that either contains the offer details or links the domain name owner to a resource that contains the details, an audio telephone call to the domain name owner's telephone that contains the offer details, a conventional mailing containing a letter that identifies the offer details, and the like.

If the domain name owner chooses to reject the offer, the domain name owner may be directed to a website enabling the domain name owner to prepare a counter offer that can be submitted back to the original requester.

Accordingly, after the domain name owner has reviewed the offer, a response to the offer is received from the domain name owner in step 302. As mentioned above, the response may be provided by the owner clicking on a link within an email, visiting a web page, transmitting a suitable text message, making a telephone call to a predetermined telephone number, and the like. In some cases, when the domain name owner takes suitable steps to provide a response to an offer, the domain name owner may be required to provide a pin or other authentication token before a request can be provided. In step 304, the response is analyzed to determine whether the domain name owner accepted the offer. If the offer was accepted, in step 306 ownership of the domain name is transferred from the domain name owner to the requester.

In circumstances where the domain name being transferred is already registered with the registrar performing the method of FIG. 3A, the domain name transfer can be executed internally without any further input from either the requester or the domain name owner in the form of a change of ownership of the domain name. In that case, the change of ownership is executed, and the financial information provided by the requester on the offer form or associated with a customer account of the requester is utilized to make the indicated payment to the domain name owner in accordance with the terms of the offer and the domain name owner's preferences in step 307. For example, if the requester provided credit card or any other payment information during the completion of the offer form (or such information is accessible from a customer account associated with the requester), that payment information may be automatically charged to complete the transfer of the domain name.

In some cases, payment must be successfully transferred before ownership of the domain name will change hands. In that case, step 307 becomes a pre-requisite before step 306, and step 307 must be successfully completed before step 306 will be initiated.

If, however, the domain name being transferred is not registered with the registrar performing the method of FIG. 3A, the registrar can instead initiate a domain transfer through the registrar of the domain name using that registrar's domain transfer procedures. In that case, payment may not be made to the owner of the domain name until the registrar has received sufficient proof that the domain name has been successfully transferred to the requester.

In some cases, to mitigate the risk for potential fraud associated with the transfer of ownership of the domain name and payment of for the same, an escrow service may be utilized to ensure that the ownership is successfully transferred before payment is released.

Generally, any suitable process may be utilized to perform the transfer of ownership of the domain name. When the domain name is not registered with the registrar, requiring a more formal domain name transfer, this may involve the registrar responsible for the domain name generating an authentication code that is transmitted to the registrar (e.g., by either the old registrar or the domain name owner). Upon receipt, the registrar can then use that authentication code to execute the transfer. This may involve, for example, the old registrar confirming with the domain name owner that the domain name transfer should take place. Upon receiving confirmation, the old registrar can release the domain name for transfer, and ownership of the domain name can be transferred to the registrar and the requester. When the domain name is registered with the registrar, a change of ownership procedure may be utilized, which may not require an authentication code.

When the transfer of ownership of the domain name from the owner to the requester is complete, in step 308 confirmation of the transfer is transmitted to the requester.

If, however, the domain name owner rejects the offer, the method moves to FIG. 3B. FIG. 3B is a flowchart illustrating a method by which a counter-offer, received from a domain name owner, can be transmitted to a requester.

In step 350 the domain name owner's response is analyzed to determine whether the response includes a counter-offer. If not, in step 352 a notification of the rejection of the offer is transmitted to the requester. If the domain name owner has simply rejected the request, then the notification transmitted in step 352 may simply indicate that the offer was rejected. In some cases, though, the domain name owner may have provided additional information in the rejection that may be communicated in the notification to the requester. The additional information provided by the domain name owner may include, for example, annotations that may communicate useful information back to the requester (e.g., the domain name is not currently for sale, but will be for sale in 6 months).

In some implementations, the domain name owner can be provided with additional options when rejecting an offer. For example, the domain name owner can be given an opportunity to ignore the offer (in which case a notification may not be sent back to the requester). The owner can also indicate a minimum value below which no more offers will be communicated to the owner. The owner may also be given an opportunity to have the registrar prevent the making of offers for the domain name at issue, so that no offers can be made or to prevent offers on all domain names belonging to the owner.

If, however, the domain name owner, in rejecting the offer, has provided a counter-offer, in step 354 the counter-offer is transmitted to the requester. The requester is then provided with an opportunity to review and accept or deny the counter-offer. In one implementation, for example, the counter-offer may be transmitted to the requester in step 354 in a manner that is similar to that used when transmitting the original offer that was transferred to the domain name owner. In general, the counter-offer may be communicated by any suitable means including, but not limited to, a reference or hyperlink to a website, where the website includes the contents and details of the counter-offer, an email message, an SMS message (i.e., text message) that either contains the offer details or links the requester to a resource that contains the details of the counter-offer, an audio telephone call to the requester's telephone that contains the offer details, a conventional mailing containing a letter that identifies the offer details, and the like. The transmission of the counter-offer may include buttons or links enabling the requester to either accept the counter-offer or reject the counter-offer. In some cases, the requester is also given the opportunity to reject the counter-offer and introduce a counter-counter-offer, which will be communicated back to the domain name owner.

Accordingly, in step 356 a response to the counter-offer is received from the requester and in step 358 the response is analyzed to determine whether the requester accepted the counter-offer or rejected the counter offer (in which case the requester may have provided a counter-counter-offer). If the requester's response indicates that the domain name owner's counter-offer was accepted, in step 360 ownership of the domain name is transferred from the domain name owner to the requester. This may involve an intra-registrar or inter-registrar transfer of ownership of the domain name, as described above and processing of payment for the domain name. In step 362, once sufficient evidence of the successful transfer of ownership has been received, the domain name owner is notified that the domain name transfer has been completed. Upon receiving confirmation that the counter-offer was accepted, the financial information of the requester can be utilized to make the indicated payment to the domain name owner in accordance with the terms of the counter-offer and the domain name owner's preferences in step 361. For example, if the requester provided credit card or any other payment information during the completion of the original offer form (or such information is accessible from a customer account associated with the requester), that payment information may be automatically charged to complete the exchange.

If, however, the domain name owner's counter-offer was not accepted, in step 364 a notification of the rejection of the domain name owner's counter-offer is transmitted to the domain name owner. If the rejection of the domain name owner's counter-offer includes a counter-counter offer, that counter-counter offer can be communicated to the domain name owner. In that case, the transmission of the counter-counter offer may resemble step 300 of the method of FIG. 3A. As such, the counter-counter offer may be communicated to the domain name owner using any suitable communication method. Examples include, but are not limited to, a reference or hyperlink to a website, where the website includes the contents and details of the counter-counter offer, an email message, an SMS message (i.e., text message) that either contains the counter-counter offer details or links the domain name owner to a resource that contains the details, an audio telephone call to the domain name owner's telephone that contains the counter-counter offer details, a conventional mailing containing a letter that identifies the counter-counter offer details, and the like.

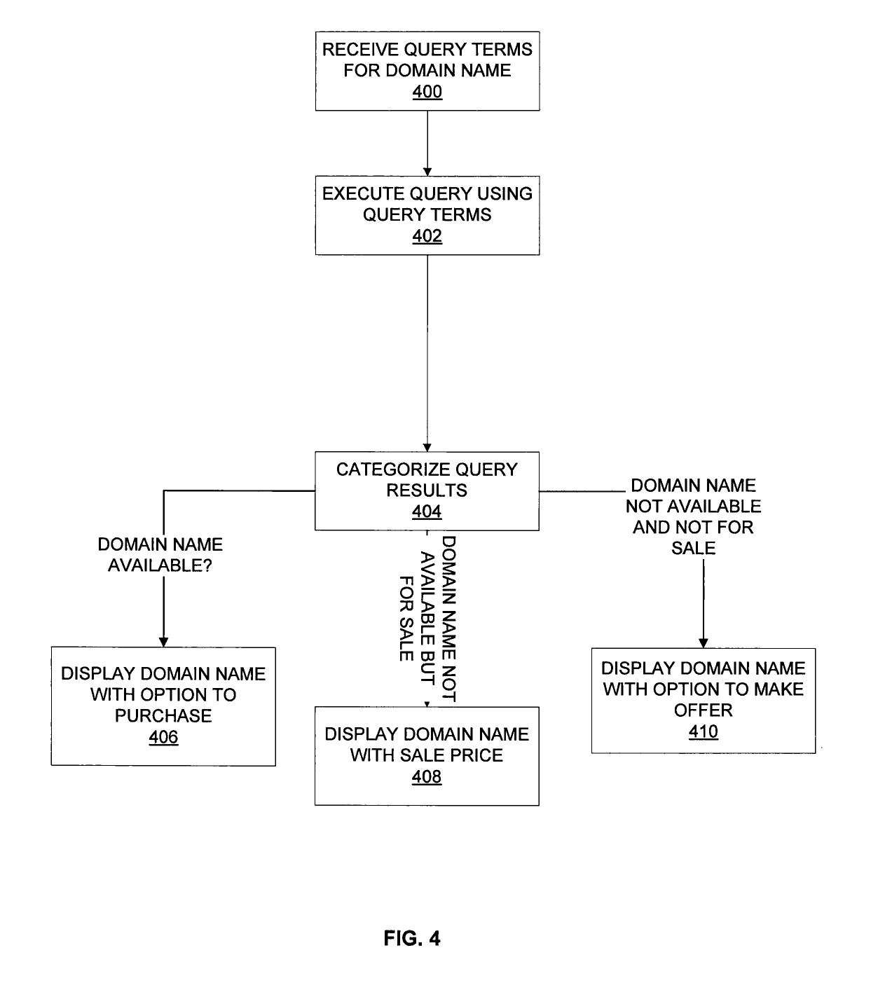

FIG. 4 is a flowchart depicting an alternative method for displaying a list of candidate domain names in response to domain name query terms supplied by a requester. The method depicted in FIG. 4 may be performed by a registrar via, for example, a domain name registration website.

In step 400 a search query is received. The search query may include a requested domain name (e.g., “company.com”) or may include a number of separate terms (e.g., bicycle repair). In alternative embodiments, the search query may include content other than a domain name or keywords. The query may generally comprise any input from which a suitable domain name may be derived or identified. Example input includes explicit input comprising any data or information provided by the requester. Example explicit input may include text (e.g., newspaper content, personal statements, “about us” information for a business, a listing of favorite items such as products or sports teams, etc.), images (e.g., images of a place of business, images of an individual, images of products, etc.), audio (e.g. recordings of a band, audio of a company's jingle, audio of a commercial), and/or video (e.g., video of a comedy performance, video of a company's commercial, and the like) that may be uploaded by the requester. The explicit input can then be analyzed (e.g., by translating visual or audio information into text data) in order to identify potentially relevant domain names. The input may also include implicit data. Implicit data is information that may be derived from the requester or the request without the requester explicitly providing the information. Implicit data may include information such as the requester's current location (potentially derived from the IP address of the requester's computer), information associated with the requester in a customer information database (e.g., the market in which a business of the requester operates, the requester's age, sex, home address, nationality, native or secondary languages, etc.). In various implementations of the present system, any combinations of explicit or implicit data may be utilized or analyzed to identify one or more candidate domain names that may then be displayed to the requester in accordance with the present disclosure.

After receiving the query, in step 402 a query is performed to identify candidate domain names based upon the query terms. The query may involve, for example, ascertaining whether a particular domain name (e.g., “company.com”) has already been registered by checking the SRS database associated with the TLD of the domain name (.com in the instant example). The query may also involve, based upon the query terms, identifying a number of candidate domain names that may incorporate the query terms or are relevant to the terms or other attributes of the requester. For example, the candidate domain names may include a number of domain names that include various combinations of the query search terms in various orderings and can be concatenated with one another in different ways.

Having generated a result set including a number of candidate domain names, the domain names in the result set are categorized in step 404 as being either available, registered and up for sale or auction, or registered and not up for sale or auction. When displaying the result set for the requester, domain names falling into the first category (e.g., unregistered) are displayed in conjunction with an option to purchase the domain name in step 406. Domain names falling into the second category (e.g., registered, but up for sale or auction) are displayed in conjunction with an option to participate in the on-going auction of the domain name in step 408. Finally, domain names that fall into the third category (e.g., registered but not currently for sale) are displayed in conjunction with an option to make an offer to purchase the domain name in step 410.

For example, referring back to FIG. 7, the user has performed a search for domain names that are relevant to the terms “arizona” and “bikes”. The result set includes a number of domain names that are available, registered but at auction, or registered and not at auction. For the available domain names (see elements 704), the user is given an opportunity to buy the domain names. For the domain names that are registered, but not at auction, as discussed above, the user is given a user interface 702 by which the user can make an unsolicited offer to purchase the domain names. Finally, for the domain names that are both registered and at auction, the user is provided with user interface 706 by which the user can make a bid on the domain name and participate in the bidding process.

In some system implementations, as the user enters a search string when searching for a potential domain name to purchase, the system can provide real-time feedback to the user to assist in the user making a search.

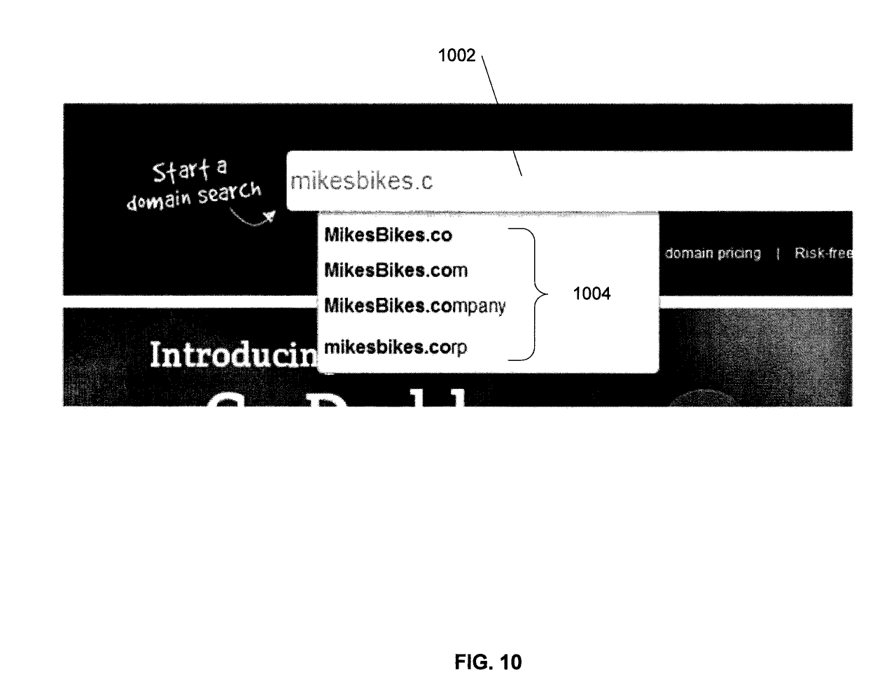

For example, while the requester types a search string into text box 600 of FIG. 6, the user's typing can be monitored and feedback can be given to the user in real-time. In one instance, the feedback can assist the user by auto-completing potential domain names for which the requester may wish to search. FIG. 10, for example, is a screenshot showing a user who, having begun typing a domain name “mikesbikes.c” into the search text box 1002 is presented with a menu of candidate domain names 1004 that include domain names that contain the text inputted by the user. In this example, the candidate domain names 1004 include domain names that include the domain name “mikesbikes” combined with candidate TLDs that belong with the letter c. The candidate domain names 1004 may include only domain names that are available for registration, or a combination of registered and un-registered domain names. The user then has the option of either completing typing the domain name into box 1002 or selecting one of the suggestions 1004, for example by clicking upon the text of one of the suggestions.

By providing a listing of suggestions, the user can be provided with TLD options that the user may not have otherwise been aware of. For example, the user may not have known that the TLD “.corp” was a potential candidate for a TLD. However, by displaying the listing of candidate domain names 1004, the user can easily view potentially new TLDs that may be used. In some cases, in addition to providing a list of candidate domain names for TLDs that match the string being type by the user, the listing of candidate domain names may include domain names for TLDs that are synonymous to the TLD or other query keywords being typed by the requester. For example, if the user begins typing a domain name with a TLD beginning with the letter “c” (because the requester is looking for domain names having to do with “cars”), the candidate listing may also include domain names that end with the TLD “.auto”, because “auto” is synonymous and/or related to “car”. Similarly, TLDs that are synonymous and/or related to the keyword or second-level domain (SLD) being entered by the user (in this example, “mikesbikes”) may also be displayed, Accordingly, in this example, because the user has entered the word “bikes” into search bar 1002, domain names having TLDs such as “.bikes” or “.exercise” may also be listed in candidate domain names 1004.

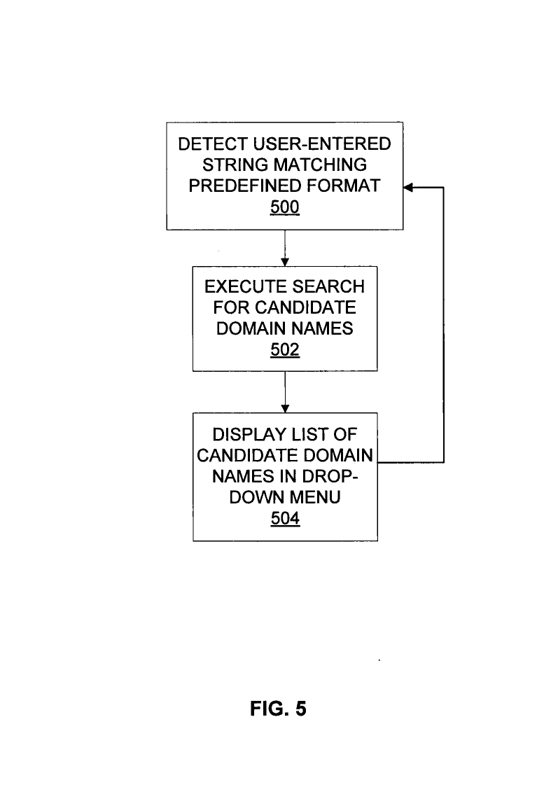

FIG. 5 is a flowchart depicting a method for providing a user with a drop list of candidate domain names. The depicted method may be performed to provide the user interface depicted in FIG. 10, for example, and may be executed by a server computer operated by a registrar and providing a domain name registration website. In step 500 it is detected that the user has entered a search string that meets a predefined pattern. In one example, the pattern is a sequence of letters (i.e., the second level domain (SLD)) followed by a period or full-stop (i.e., “.”) followed by one or more letters. The user may enter the search string into text box 1002 of FIG. 10, for example.

After detecting that the user has entered a search string matching the pattern, in step 502 a search is executed for candidate domain names that satisfy the user's query. This may be performed by first identifying a number of TLDs that match the user's query. For example, if the user has only type a single character following the “.”, all TLDs that begin with that same character can be identified. If, however, the user had type two characters following the “.”, all TLDs that begin the same two characters can be identified.

Having generating a pool of candidate TLDs, a number of candidate domain names can be generated. In one implementation, the candidate domain names are generated by combining the SLD portion of the user's query with every potential TLD. In that case, some of the candidate domain names may already be registered. In other implementations, however, before displaying a particular candidate domain name, the SRS records for the relevant TLD are checked to see if the candidate domain name has already been registered. If the candidate domain name has already been registered it may not be displayed in the listing of candidates.

After the listing of candidate domain names has been generated, the listing can be displayed in step 504 in a drop-down menu (see, for example, element 1004 of FIG. 10). After displaying the listing of candidate domain names, the method returns to step 500 and continues to monitor the user's activities to see if the search string has been modified, in which case a new listing of candidate domain names can be prepared and displayed.

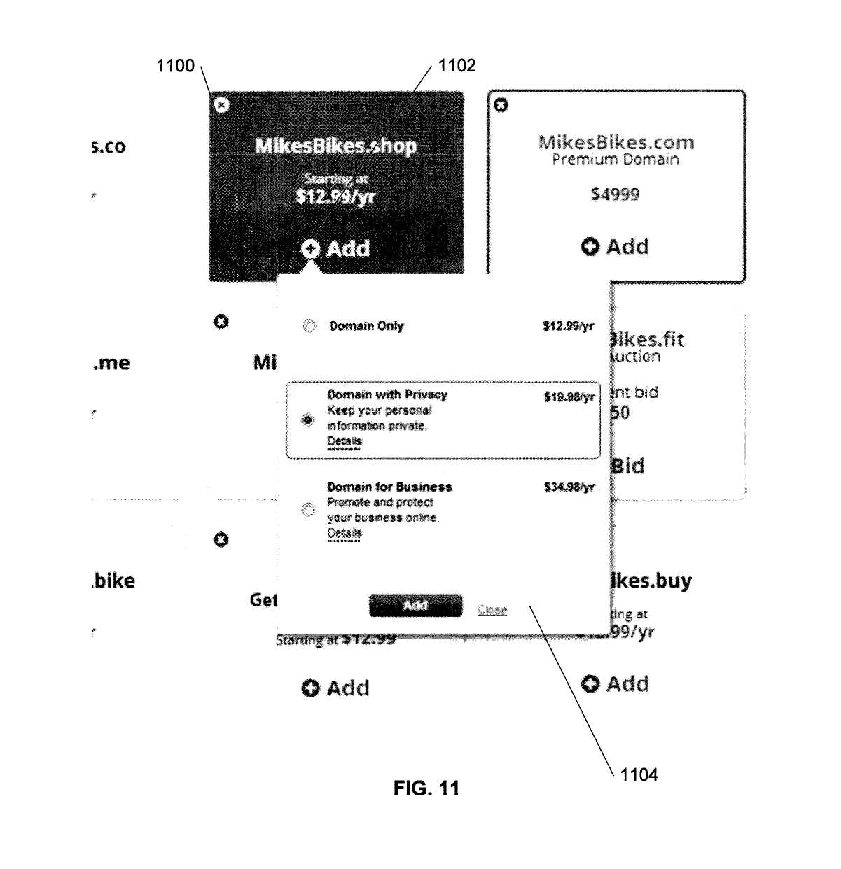

In the present system, when displaying a number of candidate domain names that may be purchased or registered by a user, the listing of domain names may take any format. For example, the domain names may be displayed in a list or can be depicted graphically in the form of a number of tiles. FIG. 11, for example, is a screenshot depicting a number of candidate domain names in a tile configuration. If the user wishes to purchase one of the domain names, the user first identifies the desired domain name and clicks up on the “Add” button. In the depicted example, the user has clicked upon the add button 1102 for domain name 1100. This action brings up secondary menu 1104. Secondary menu present a number of options that may be utilized when purchasing domain name 1100. For example, the user may select to purchase the domain only, or may purchase the domain as well as additional features, such as privacy-related features, or business-related features.

The options depicted in secondary menu 1104 may vary depending upon the type of domain name being purchased. In one example, the options are dependent upon the TLD of the domain name being purchased. For example, certain TLD's (e.g., domain names having the TLD “.us”) are considered restricted in that they are not eligible for specific domain add-ons like private WHOIS records due to registry restrictions. In that case, a domain name for which a private WHOIS registration is not eligible may be eligible for alternative add-ons such as business registration or certified registration. The depicted options can then vary based on what is allowed for a specific TLD.

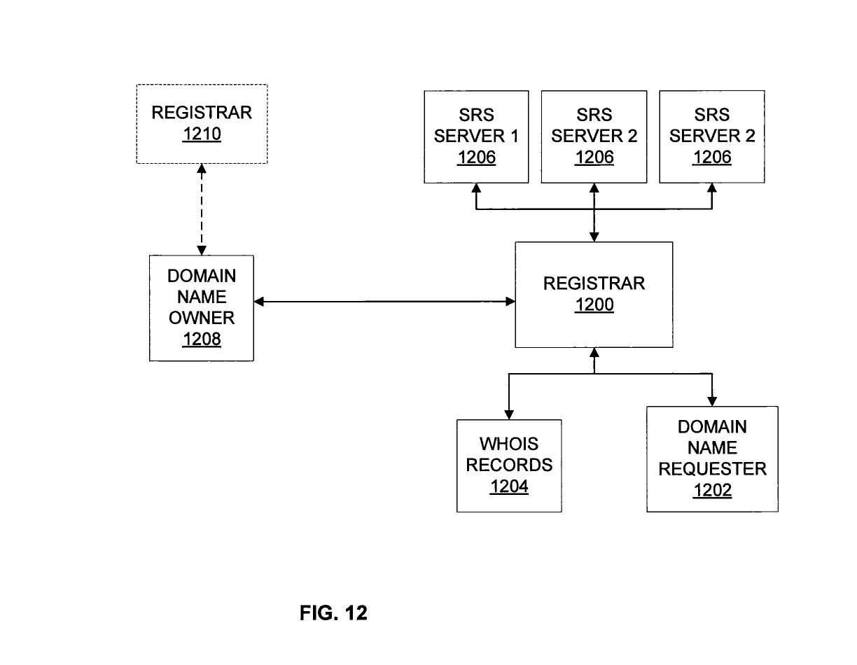

FIG. 12 is a block diagram depicting an example environment in which embodiments of the present methods may be performed. The example environment includes registrar 1200 configured to host a domain name registration website enabling users to search for, register, and make offers upon domain names. Registrar 1200 may communicate with the other entities depicted in FIG. 12 (and they may communicate with one another) using a network. The network may communicatively couple registrar 1200 to domain name requester 1202. The example embodiments herein place no limitation on the network configuration or connectivity. Thus, as non-limiting examples, the network could comprise the Internet, the public switched telephone network, the global Telex network, computer networks (e.g., an intranet, an extranet, a local-area network, or a wide-area network), wired networks, wireless networks, or any combination thereof. Domain name requester 1202 may include a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture with which a user can search for and make an offer upon a domain name.

The components of the environment depicted in FIG. 12 may be communicatively coupled to the network via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (Ti, Frame Relay), Point-to-Point Protocol over Ethernet (PPPoE), and/or any combination thereof.

Registrar 1200 operates a website comprising any collection of data and/or files accessible via a browser by domain name requester 1202. The website of registrar 1200 may be provided by at least one server and/or any other server described herein, executing any computer or program that provides services to other computers, programs, or users either in the same computer or over a computer network.

The website provided by registrar 1200 may have one or more fields for submitting a request for an available domain name and submitting an offer therefore in accordance with the methods of the present disclosure. The provided request may or may not include a keyword, search term, or suggested domain name. The request may include any explicit or implicit input that may be utilized to identify one or more candidate domain names that are relevant to the request. As discussed above, the request may include text, images, audio, or other any other content, optionally in combination with implicit information.

Registrar 1200 can communicate via the network with WHOIS records service 1204. WHOIS records server 1204 stores WHOIS records for a number of domain names and may be utilized by registrar 1200 to identify the owner of a domain name and to retrieve contact information for that owner. Similarly, registrar 1200 is also in communication with a number of SRS servers 1206. SRS servers 1206 store databases containing records relating to the registration status for domain names within particular TLDs. Accordingly, registrar 1200 can access the SRS servers 1206 to determine whether a particular domain name has been registered.

Domain name owner 1208 represents the entity that owns a registration for a particular domain name. The registration for the domain name may have been made with registrar 1200 or with another registrar 1210.

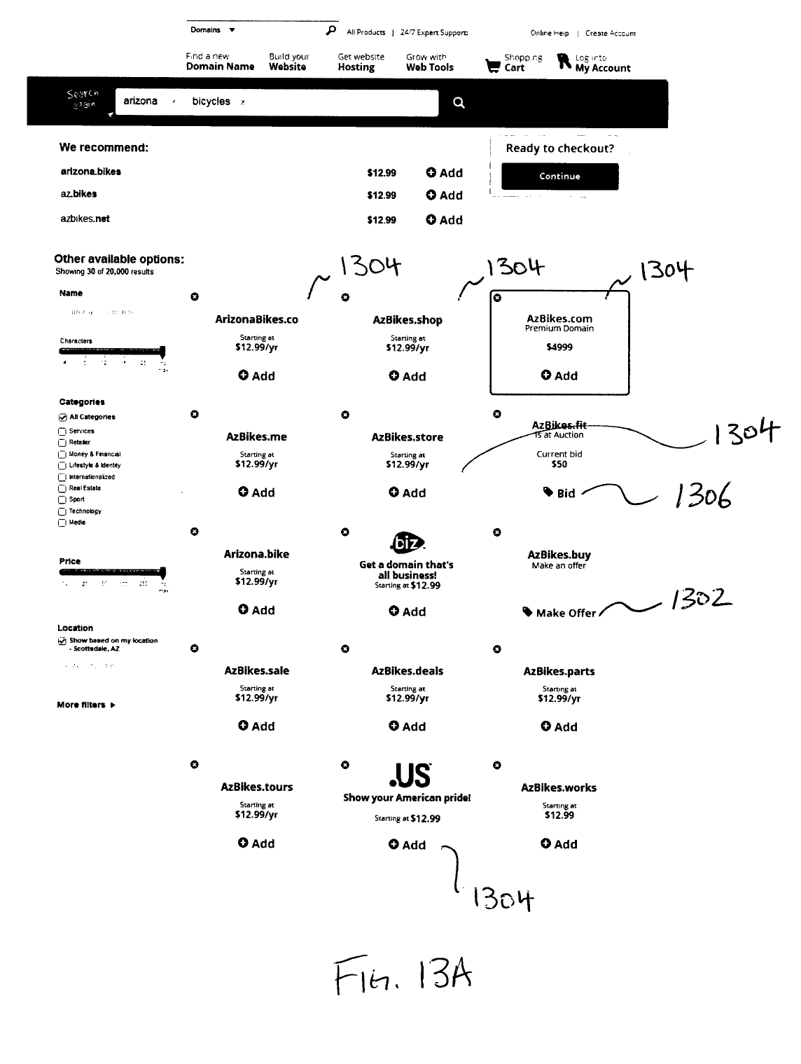

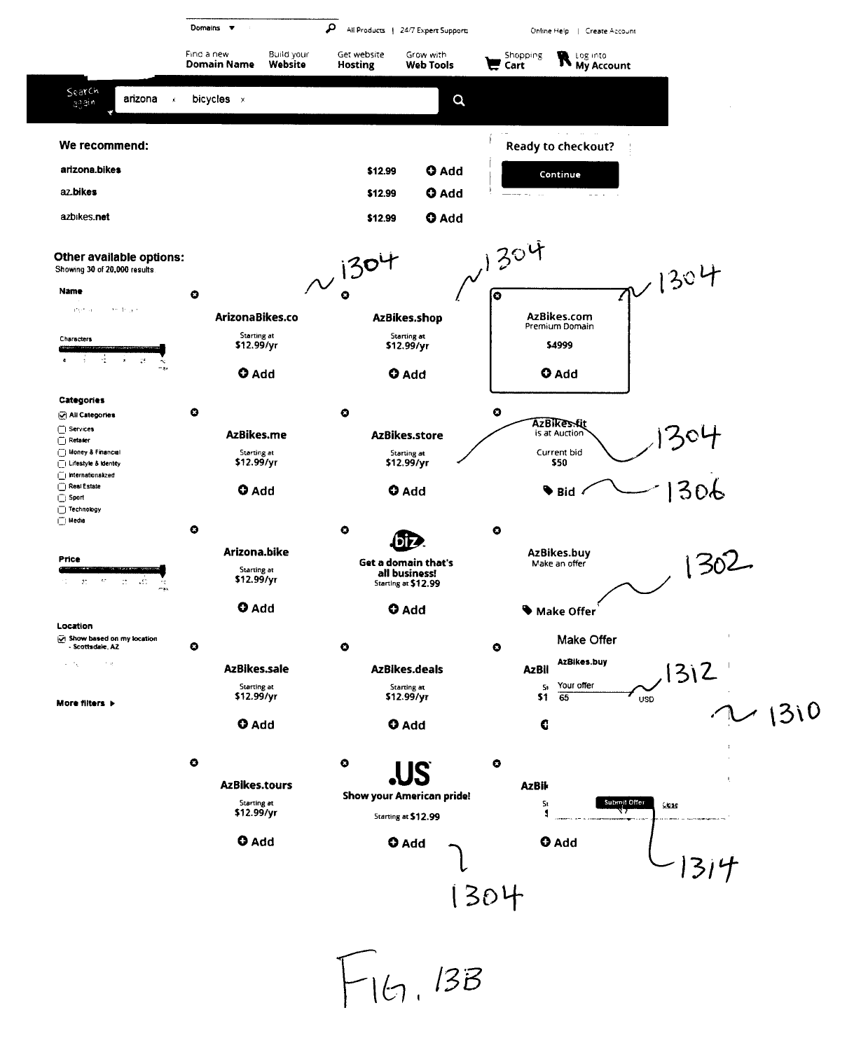

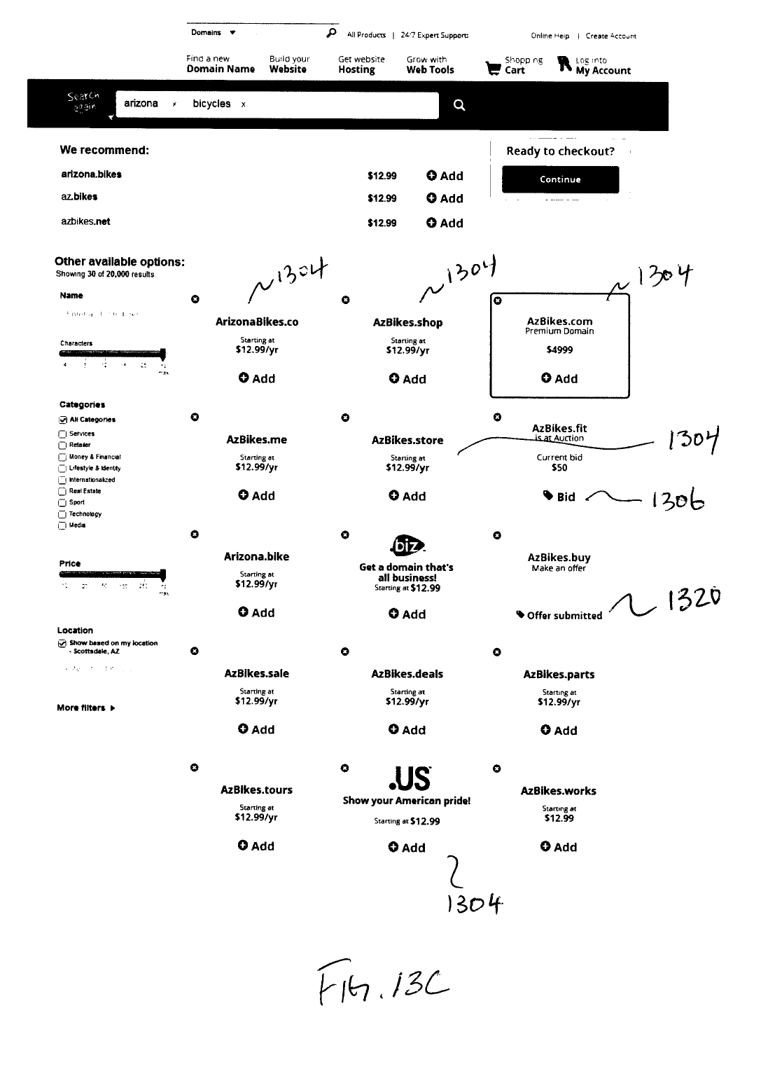

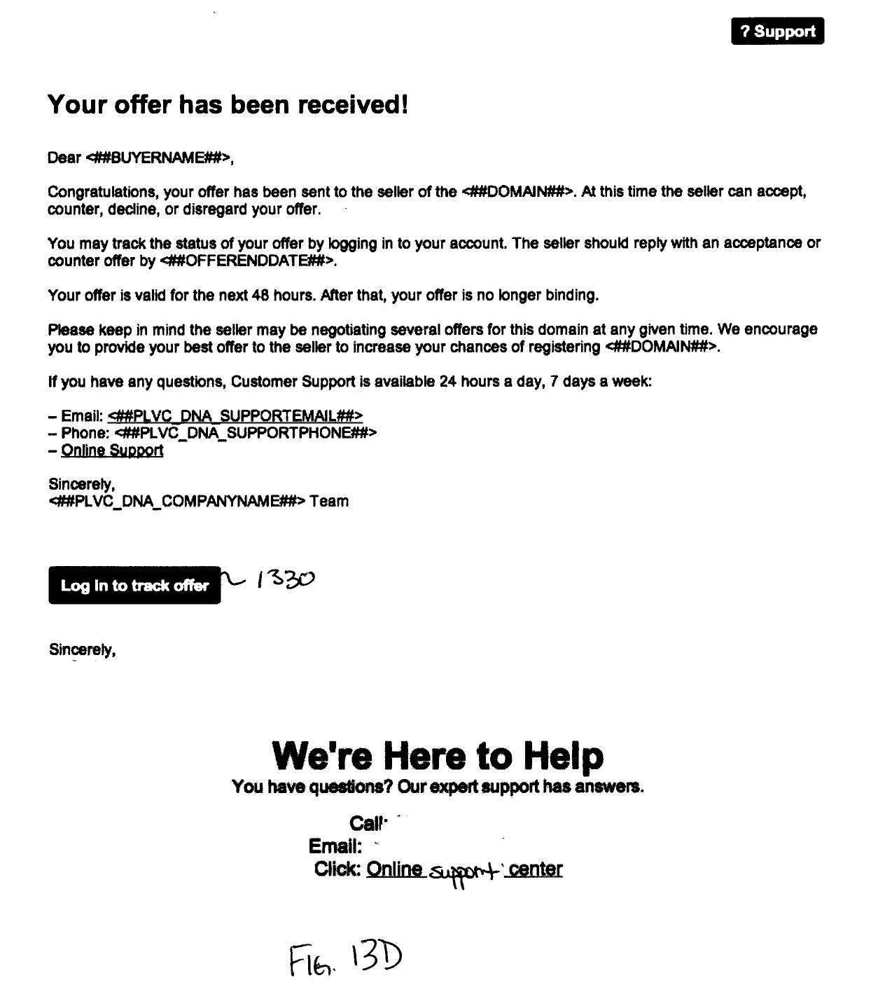

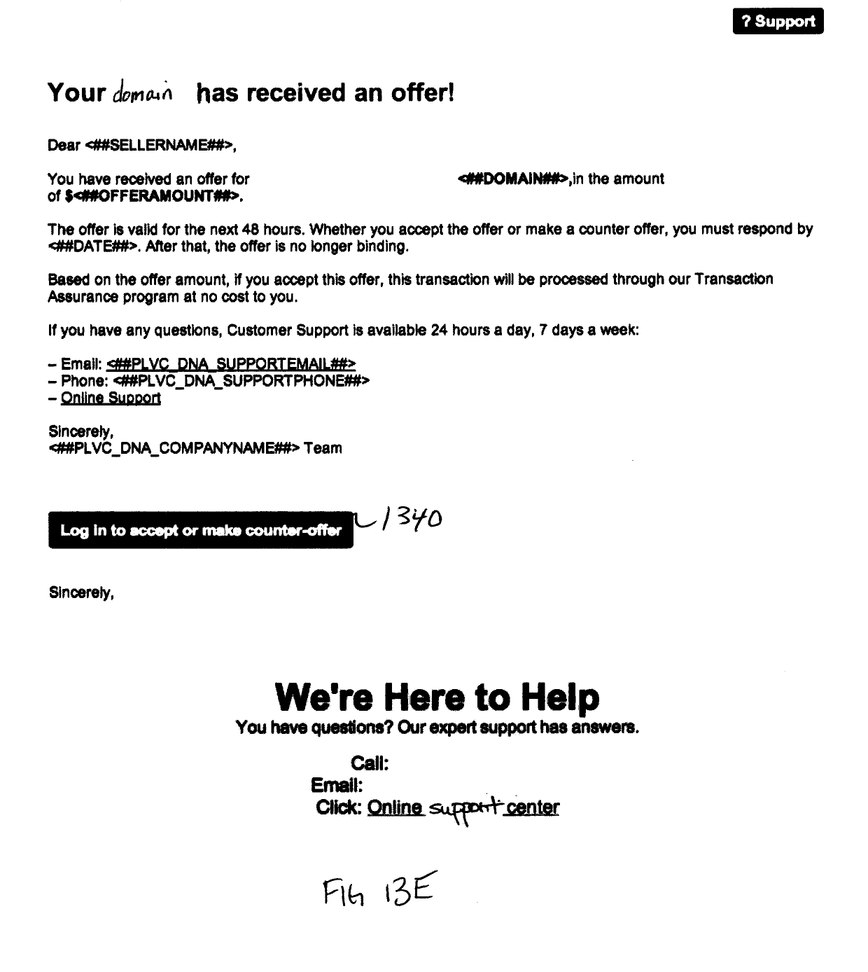

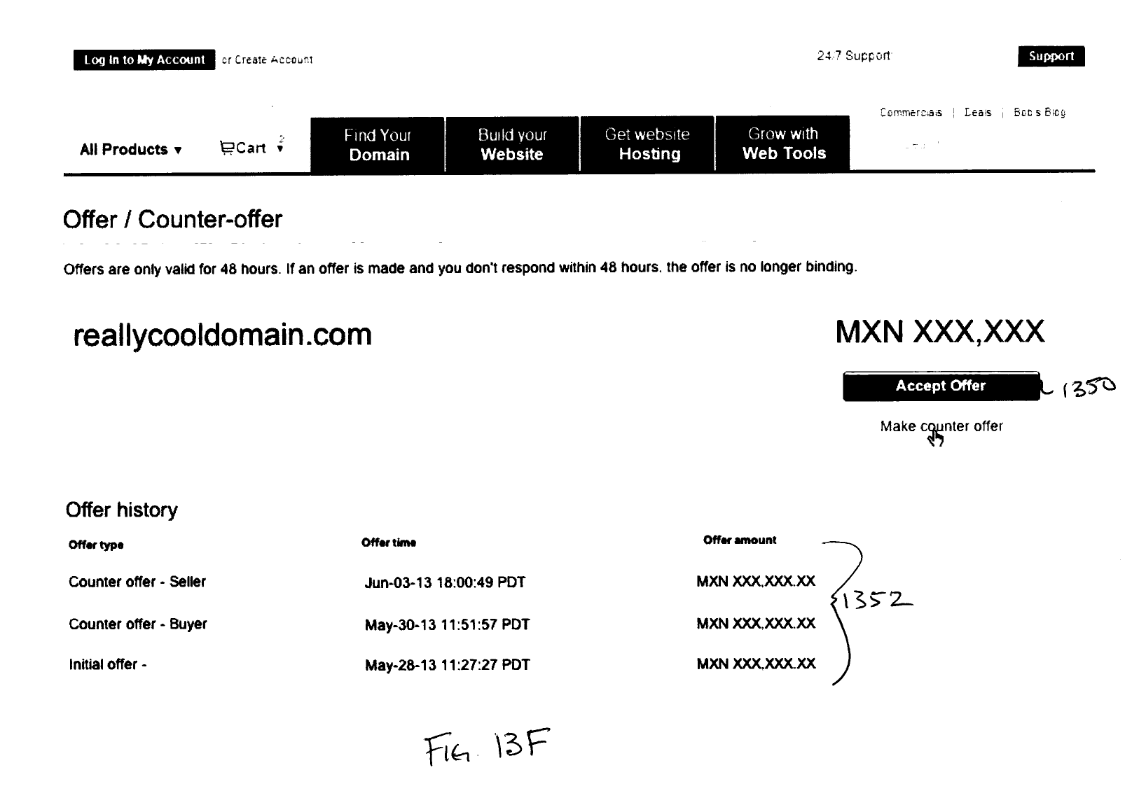

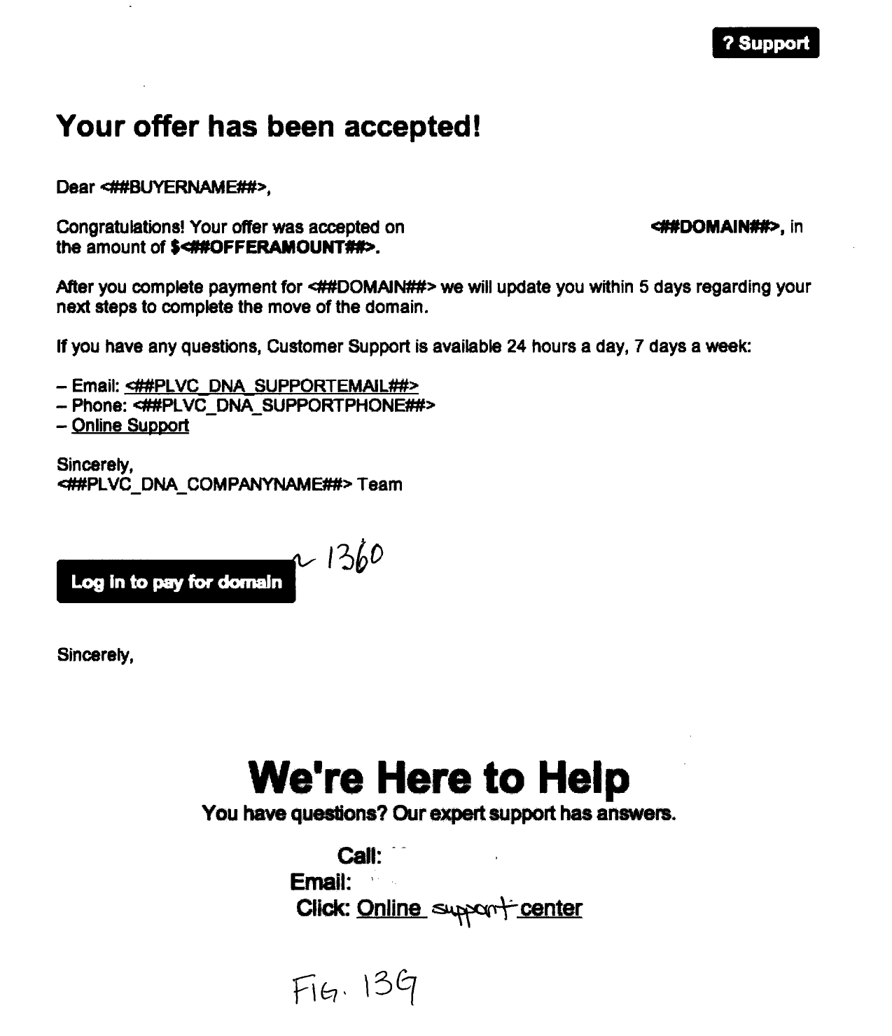

FIGS. 13A-13G are a series of screenshots showing an example use case for the present system in which a requester searches for a candidate domain name and then submits an offer to purchase that domain name.

FIG. 13A is a screen shot showing an example user interface displaying a listing of results in response to the requester's query for a domain name. As seen in FIG. 13A, the requester has performed a search for the candidate domain names using the keywords “arizona” and “bicycles”.

Having performed a search for candidate domain names relevant to those keywords, the registrar's system has made the determination that a number of relevant domain names exist. Some of the relevant domain names are available for purchase, some are already registered, but for sale (e.g., via an auction or direct sale), and some are registered, but not up for auction or on sale.

In the result listing, for the domain names that are not registered (see element 1304), such as AzBikes.shop and AzBikes.co, the requester is given an option to simply purchase those domain names. For domain names that are on sale or, for example, at-auction, the requester is given an opportunity to purchase or participate in the auction process by clicking on link 1306. For domain names that are registered, but not at-auction, such as the domain name AzBikes.buy, the requester is given an opportunity to make an offer to purchase the domain name using link 1302.

If the requester wishes to make an offer to purchase the domain name AzBikes.buy, for example, the requester clicks upon user interface 1302 to initiate the offer process.

FIG. 13B depicts a user interface enabling a requester to enter an offer to purchase an already-registered domain name after selecting link 1302 of FIG. 13A. In FIG. 13B the offer form is displayed as part of the search results that were generated in response to the requester's searching for candidate domain names. The result set may be similar, for example, to that displayed in FIG. 13A. In FIG. 13B, the user has activated user interface 1302 to make an offer for the domain name “AzBikes.buy”. After activating the “make offer” user interface 1302, the requester is presented with pop-up form 1310 enabling the requester to submit an offer to purchase the domain name. Form 1310 includes input 1312 in which the requester can enter a monetary amount for the offer. Once the monetary amount has been entered into input 1312, the requester can activate user interface 1314 to submit the offer.

After the requester has submitted the offer using user interface 1314, pop-up form 1310 is removed and the requester is again presented with a result listing. However, as shown in FIG. 13C, once the offer has been submitted, the result listing is updated with notification 1320 to notify the user that an offer has been submitted for the relevant domain name—in this case “AzBikes.buy”.

Once the offer has been submitted, the requester is provided with a confirmation that the offer was successfully received by the registrar. FIG. 13D shows an example confirmation that may be transmitted to the requester confirming successful receipt of the offer by the registrar. The confirmation identifies relevant information in the offer, such as the domain name for which the offer was made, the amount of the offer, and the time period after which the offer will expire. The confirmation may also provide useful information to the requester that can be used to gather more information about the domain name purchase process, such as contact information for help services.

The confirmation may be communicated to the requester by any suitable mechanism, such as via an email message. In that case, the email message may contain the content of the confirmation, or include a button or link that the requester can activate to view the confirmation. The email may direct the requester to visit a website before the confirmation can be viewed, for example by displaying a hyperlink that the requester can click on to open a website depicting the details of the offer.

The confirmation depicted in FIG. 13D also includes a button or other user interface 1330 that allows the requester to view a status of the requester's pending offer. Upon clicking on button 1330, for example, the requester can open a website or other user interface that provides information regarding the status of the offer and, in some cases, the status of the requester's other offers, should any exist. Example statuses may include whether a particular offer has been successfully sent to a domain name owner, whether the offer has been read, whether the offer has been accepted or rejected, whether a counter-offer has been received for the offer, and the like.

Once the requester submits an offer, a formal offer is also transmitted to the domain name owner. FIG. 13E depicts an example formal offer that may be communicated to a domain name owner after the requester has submitted an offer. The formal offer includes a description of the domain name for which the offer was made, as well as the monetary amount of the offer. The formal offer communicated to the domain name owner may also set forth the period of time during which the offer is valid.

The formal offer of FIG. 13E can be transmitted to the domain name owner via an email message, in which the email message contains the entire contents of the offer or where the email message may include a button or other user interface 1340 that, once activated, directs the domain owner to visit a website before the offer can either be accepted or rejected. Before being able to either accept or reject the offer, the domain name owner may be required to provide authentication tokens (e.g., username and password) to log into the domain name owner's account with the registrar.

In other implementations, the button 1340 may instead allow the domain name owner to accept the offer, without performing any additional action. In that case, once button 1340 is activated, the domain name transfer will take place automatically, and payment will be automatically processed to the domain name owner using financial information provided by the requester to the registrar previously (for example, either as part of the original offer or as part of the requester's customer information).

In general, the offer may be communicated to the domain name owner using any suitable communication method. Examples include, but are not limited to, a reference or hyperlink to a website, where the website includes the contents and details of the offer, an email message, an SMS message (i.e., text message) that either contains the offer details or links the domain name owner to a resource that contains the details, an audio telephone call to the domain name owner's telephone that contains the offer details, a conventional mailing containing a letter that identifies the offer details, and the like.

FIG. 13F depicts a user interface enabling a domain name owner to view more information relating to the formal offer of FIG. 13E. The user interface may be displayed, for example, after the domain name owner activates button 1340 depicted on FIG. 13E. Alternatively, the information depicted in FIG. 13F may also be displayed as part of a user's homepage or portal upon logging into the registrar's website. In the interface depicted in FIG. 13F, a historical listing of activities associated with the offer is listed, as indicated by element 1352. The historical listing may identify one or more counter offers that may have been made before the most current offer and provide additional information describing each historical activity. The interface also includes a button 1350 enabling the domain name owner to accept the offer.

Finally, once the offer has been accepted by the domain name owner, a notification of the same is transmitted back to the requester. FIG. 13G shows an example notification that may be transmitted to the requester indicating that their offer was accepted. The notification identifies the domain name upon which the offer was accepted as well as the monetary amount. The confirmation may also provide useful information to the requester that can be used to gather more information about the domain name purchase process, such as contact information for help services.

The notification may be communicated to the requester by any suitable mechanism, such as in an email message. In that case, the email message may include a button or link that the requester can activate to view the notification. In other implementations, the email may direct the requester to visit a website before the notification can be viewed, for example by displaying a hyperlink that the requester can click on to open a website depicting the details of the notification.

As shown in FIG. 13G, the notification includes a button 1360 that may be activated by the requester to log into the registrar's website and pay for the domain name in accordance with the terms of the offer. In other implementations, though, where, once the offer is accepted, domain name transfer and payment occur automatically, the notification of FIG. 13G would not include a mechanism enabling the requester to pay for the domain name as payment would have already occurred.

As a non-limiting example, the steps described above (and all methods described herein) may be performed by any central processing unit (CPU) or processor in any computer or computing system, such as a microprocessor running on a server computer, and executing instructions stored (perhaps as applications, scripts, apps, and/or other software) in computer-readable media accessible to the CPU or processor, such as a hard disk drive on a server computer, which may be communicatively coupled to a network (including the Internet). Such software may include server-side software, client-side software, browser-implemented software (e.g., a browser plugin), and other software configurations.

The present disclosure describes preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

The invention claimed is:

1. A method, comprising:
providing, by at least one server communicatively coupled to a network, a domain name registration website, the domain name registration website including a user interface;
monitoring a query being entered by a requester into the user interface of the domain registration website;
when the query being entered by the requester matches a predefined pattern:
using the query to identify a plurality of candidate domain names, and
displaying the candidate domain names for selection by the requester on the domain name registration website.

2. The method of claim 1, including, for each of the plurality of candidate domain names, determining whether the candidate domain name is registered and, when the candidate domain name is registered, not displaying the candidate domain name for selection by the requester.

3. The method of claim 2, wherein determining whether the candidate domain name is registered includes communicating with a Shared Registration System to determine whether the candidate domain name is registered.

4. The method of claim 1, wherein the pattern includes a first letter followed by a “.” symbol followed by a letter.

5. The method of claim 1, wherein the query includes a string and each one of the candidate domain names includes the string.

6. The method of claim 1, wherein second level domains of each of the plurality candidate domain names are the same and top level domains of each of the plurality of candidate domain names are different.

7. The method of claim 1, including:
receiving, from the requester, a selection of a first one of the candidate domain names on the domain name registration website; and
displaying the first one of the candidate domain names for purchase by the requester.

8. The method of claim 7, including, after receiving, from the requester, a selection of a first one of the candidate domain names on the domain name registration website, displaying a plurality of purchase options associated with the first one of the candidate domain names.

9. The method of claim 8, wherein the purchase options include at least one of a privacy option, and a business option.

10. A method, comprising:
receiving, by at least one server communicatively coupled to a network, a request from a requester;
using the request to identify a domain name;
determining whether the domain name is registered; and
when the domain name is not registered:
displaying the domain name,
displaying a first user interface enabling the requester to purchase the domain name, and
displaying a plurality of purchase options associated with the domain name, the plurality of purchase options being determined by a top level domain of the domain name.

11. The method of claim 10, wherein determining whether the candidate domain name is registered includes communicating with a Shared Registration System to determine whether the candidate domain name is registered.

12. The method of claim 10, wherein the purchase options include at least one of a privacy option, and a business option.

13. A system, comprising:
a server hosting a domain name registration website via a network and being configured to communicate over the network with a client computer, the server being configured to:
display a user interface on the domain name registration website;
monitor a query being entered by a requester into the user interface of the domain registration website via the client computer;
determine whether the query being entered by the requester matches a predefined pattern; and
when the query being entered by the requester matches the predefined pattern:
use the query to identify a plurality of candidate domain names, and
display, via the client computer, the candidate domain names for selection by the requester on the domain name registration website.

14. The system of claim 13, wherein the server hosting the domain name registration website is configured to, for each of the plurality of candidate domain names, determine whether the candidate domain name is registered and, when the candidate domain name is registered, not display the candidate domain name for selection by the requester.

15. The system of claim 14, wherein determining whether the candidate domain name is registered includes communicating with a Shared Registration System to determine whether the candidate domain name is registered.

16. The system of claim 13, wherein the pattern includes a first letter followed by a “.” symbol followed by a letter.

17. The system of claim 13, wherein the query includes a string and each one of the candidate domain names includes the string.

18. The system of claim 13, wherein second level domains of each of the plurality candidate domain names are the same and top level domains of each of the plurality of candidate domain names are different.

19. The system of claim 13, wherein the server hosting the domain name registration website is configured to:
receive, from the client computer, a selection of a first one of the candidate domain names on the domain name registration website; and
display the first one of the candidate domain names for purchase.

20. The system of claim 19, wherein the server hosting the domain name registration website is configured to, after receiving the selection of the first one of the candidate domain names, display a plurality of purchase options associated with the first one of the candidate domain names on the domain name registration website.
